(19) United States
(12) Patent Application Publication
(10) Pub. No.: US 2024/0209961 A1
(43) Pub. Date: Jun. 27, 2024

(54) FASTENING DEVICE FOR FIXING TWO CABLES

(71) Applicant: Continental Automotive Systems, Inc., Auburn Hills, MI (US)

(72) Inventors: Christopher Hopkins, Holly, MI (US); Aia Analhi Blancas Benitez, Queretaro (MX); John Bruce Horst, Fenton, MI (US); Frederic Seyfarth, Sterling Heights, MI (US)

(73) Assignee: Continental Automotive Systems, Inc., Auburn Hills, MI (US)

(21) Appl. No.: 18/544,797

(22) Filed: Dec. 19, 2023

Related U.S. Application Data
(60) Provisional application No. 63/434,261, filed on Dec. 21, 2022.

(51) Int. Cl. F16L 3/10; F16L 3/11; F16L 3/237

(52) U.S. Cl. CPC F16L 3/1075; F16L 3/11; F16L 3/237

(57) ABSTRACT

A cable fastening device includes an arrangement of a first clip and a second clip configured to engage around a cable, a fixing element including a guide element and a retaining element, and a mount which at least partially surrounds the arrangement of the first clip and the second clip with respect to a casing surface thereof. The guide element is mechanically connected to the arrangement of the first clip and the second clip. The retaining element is configured to mount the fastening device in a fixed position. And, the guide element is mounted in the arrangement of the first clip and the second clip in the mount.

### CROSS-REFERENCE TO RELATED APPLICATIONS

The present application claims the benefit of U.S. Provisional Patent Application No. 63/434,261 filed on Dec. 21, 2022, in the U.S. Patent and Trademark Office, the disclosure of which is herein incorporated by reference in its entirety.

### BACKGROUND

### 1. Field

Embodiments of the present application relate to a fastening device, and more particularly to a fastening device for fixing two cables.

### 2. Description of Related Art

When laying cables or flexible supply lines in a route-bound manner in space, the cables or flexible supply lines must be fastened at fixing points. This is done either by fixing means, such as brackets, on the main structure, the fixing means receiving a cable or flexible supply line. Alternatively, the fixing means are fitted to the cable or flexible supply line and are connected to the main structure by means of a joining method.

Rigid fixing means are usually fitted to cables or flexible supply lines. The rigid fixing means are fixedly connected in a preliminary assembly process, so that the fixing means are axially rotated during the laying process on account of the route guidance. A separate fixing means is used for each type and situation of joining connection. The fixing means generally have several parts. During laying, the cable or the flexible supply lines must be rotated into the appropriate joining position by applying force. The stresses introduced in this way continue from joining position to joining position, and adversely affect the laying rate and the accuracy of the route.

An attempt is made to follow the route as accurately as possible by axially orienting the fixing means during assembly. This involves a high level of expenditure on assembly and testing and therefore expense.

Bearing points are fitted in a separate manufacturing process (injection-molding, shrink-fitting). Furthermore, annular fixing means which can be closed on one side and can freely rotate in the axial direction are mounted. This involves an additional manufacturing step and therefore expense. Changes in the position on the cable or the flexible supply line are associated with a high level of expenditure.

### SUMMARY

Objects and aspects of embodiments of the present application relate to a fastening device for fixing at least two cables, which fastening device is relatively inexpensive and/or reliable and/or allows improved or simple mounting of at least one cable and/or improves the fixing of the cables with respect to the flexible and, in this case, in particular defined orientation of the cables.

The fastening device according to an embodiment for fixing at least two cables comprises, preferably, an arrangement of at least two clips for receiving and/or fixing of at least two cables, wherein the arrangement of the two clips is designed such that it can or does at least partially engage around a cable each and can or does clamp the cable in a force-fitting and/or interlocking manner, and wherein the fastening device has a fixing element which comprises a guide element and a retaining element, wherein the guide element is mechanically connected to the arrangement of the two clips, and the retaining element is designed such that it allows the fastening device to be mounted in a fixed position.

It is preferred for the guide element to be mounted in the arrangement of the two clips in a mount which at least partially surrounds the arrangement of the two clips with respect to its casing surface. This is to be understood to mean, in particular, that the guide element is mounted in the at least partially surrounding mount, of the arrangement of the two clips or the body and/or casing of the arrangement of the two clips itself.

It is expedient for the at least partially surrounding mount of the arrangement of the two clips to have two grooves for mounting the guide element, the grooves being designed such that they each receive an edge or side of the guide element, and in particular wherein the grooves are each designed substantially along the curvature of the casing surface.

The guide element preferably has a panel which, or the base surface of which, is substantially in the form of a casing surface segment of a cylinder and/or in particular is designed to correspond to the curvature profile of the casing surface of the arrangement of the two clips or is designed depending on the curvature profile.

It is preferred for the arrangement of the two clips to be designed such that it can engage around a cable each at least partially in a force-fitting manner and fix the cable, so that each cable is secured against rotation and displacement in the arrangement of the two clips by each clip having retaining means, in particular retaining ribs, which can clamp the cable on its outer circumference.

The retaining means of the arrangement of the two clips are expediently in the form of retaining ribs and/or retaining protrusions and/or retaining fins.

The retaining ribs of the clip are particularly preferably hollow and/or not solid and also elastic. The retaining ribs very particularly preferably have a wall thickness which is lower than one third or, in particular, one fifth of the average width of the retaining ribs or of the height of the retaining ribs.

It is expedient for the retaining ribs to be substantially trapezoidal with respect to their cross-sectional area and/or their profile, in particular the inwardly facing side surface of the retaining ribs, which is designed to mount each cable, is rounded, wherein the rounded portion is in the form of a recess in the top surface of the retaining ribs.

It is preferred for the arrangement of the two clips to be of integral design, wherein it has two segments which are connected to one another on one side, in particular by means of a film hinge and/or by means of an elastic web, and wherein the other side can be folded open and folded closed and has an interlocking closure means.

The mount, comprising the two grooves, and also the guide element which is mounted in this mount are expediently designed such that relative movements along the curvature or the circumferential line of the casing surface of the arrangement of the at least two clips between the arrangement of the two clips and/or its body itself and the fixing element are possible.

The inside diameter of the space spanned by the retaining ribs of each clip is preferably somewhat smaller than the outside diameter of the cable or flexible supply line which is to be received and clamped. Owing to the mechanical stress or force-fitting clamping generated as a result, a clamping action or an interlocking connection between the cable and retaining ribs is generated in particular, wherein the cable and retaining ribs are each slightly deformed. This prevents an axial relative movement or displacement between the cable and the clip.

Grooves which receive the semicircular mating segment of the variable fixing means by means of an undercut are expediently fitted on the first and second segments of each clip, in particular centrally or symmetrically with respect to the central cross-sectional area through each clip. Before the cables or the flexible supply line is deposited and the arrangement of the two clips is folded closed, the guide element of the fixing element is placed or inserted into the mount which is formed by the grooves.

It is expedient for the at least one retaining element of the fixing element to be in the form of a tap or arrowhead or “Christmas tree.” In this case, the retaining element is designed, in particular, such that it can be inserted into a recess or bore, particularly preferably in a vehicle body, and can be fastened and can be fixed therein.

Expediently the arrangement of two clips is formed the way, that the two clips are arranged side by side, preferably out of one piece of plastic that form a combined double clip to each engage around a cable side by side.

In particular the at least two clips of the arrangement of the at lest two clips have different dimensions, especially a different inner diameter.

Expediently the arrangement of two clips is of an integral design, wherein the two segments each feature half a clip side by side, wherein the two segments are designed, as the two segments are combined, they form two full clips, each for surrounding and fixing a cable.

Preferential each half of a clip, which are formed side by side in each segment, are each formed as a half-shell, open to the side, where it is jointed with the half-shall of the other segment.

Expediently the arrangement of clips comprises three or four or more clips side by side.

Aspects and objects of embodiments of the present application also relate to the use of the fastening device for fixing at least two cables in motor vehicles, in this case in particular for fixing the cables of a wheel rotation speed sensor to the vehicle body and/or to attached parts of the vehicle or the vehicle body and a brake cable additionally.

### BRIEF DESCRIPTION OF THE DRAWINGS

Aspects and objects of the embodiments are more fully described in the following description of exemplary embodiments, with reference to Figures.

FIG. 1 is a diagram illustrating a fastening device according to an embodiment of the present application; and

FIG. 2 is a diagram illustrating a fastening device according to an embodiment of the present application.

### DETAILED DESCRIPTION

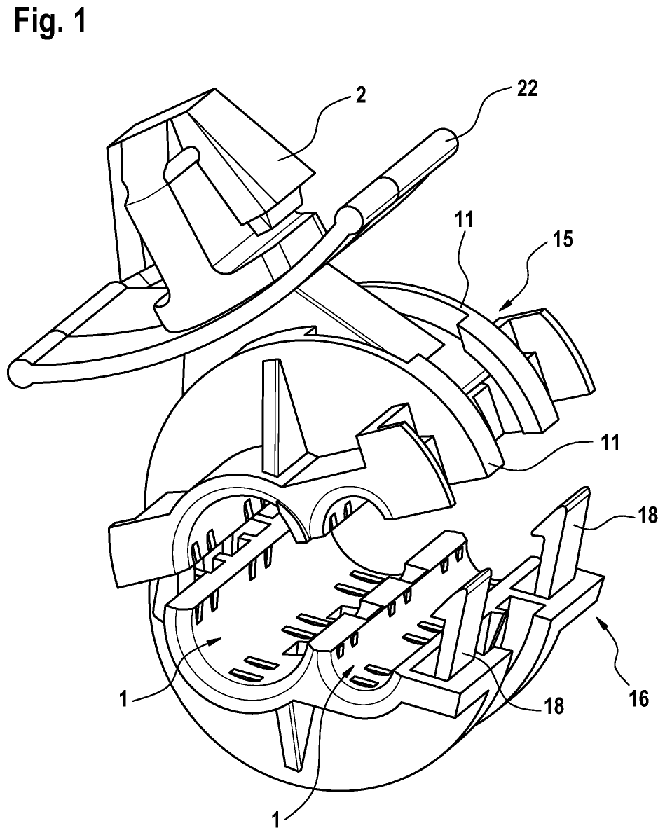

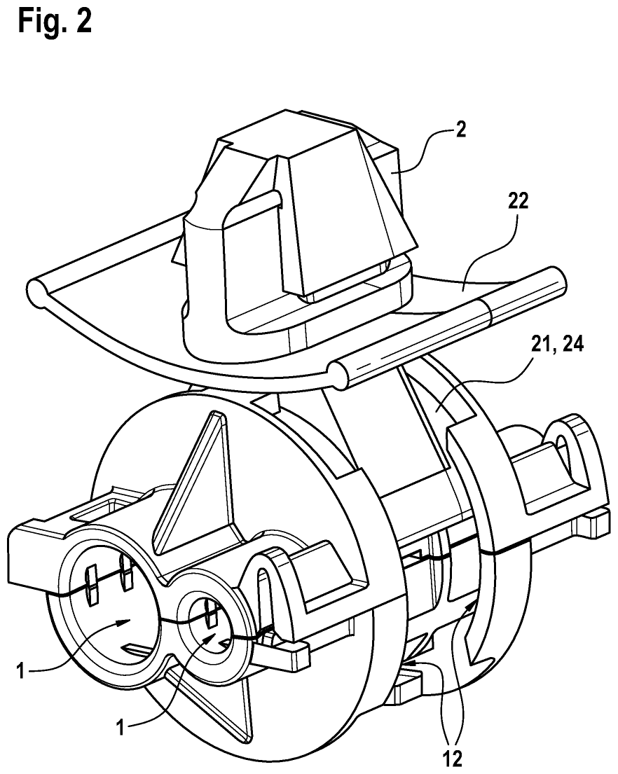

FIGS. 1 and 2 are diagrams illustrating a fastening device according to an embodiment of the present application. As illustrated in FIG. 1, the fastening device includes an arrangement of two clips 1 side by side, of different inner diameter, wherein the arrangement has a first and a second segment 15, 16, which segments are connected to one another by means of a film hinge or an elastic web. The two clips each have internal retaining ribs which are designed to receive and mount and clamp a cable. The arrangement of two clips 1 has two grooves which form a mount 11 which is designed such that it mounts the guide element 21 of the fixing element, see FIG. 2, with respect to the casing surface of the arrangement of the two clips in a manner at least partially surrounding the guide element 21.

The mount 11, comprising the two grooves 12, and also the guide element 21 which is mounted in this mount, see FIG. 2, are designed such that relative movements along the curvature or the circumferential line of the casing surface of the arrangement of the two clips 1 between the clip itself and the fixing element are possible.

The clip 1 also comprises a closure means 18 which connects or can connect the two segments 15, 16 in an interlocking manner and closes or can close the clip arrangement, wherein the closure means is designed such that this closing operation takes the form of a linking operation and/or latching operation.

The fastening device comprises also fixing element 2 of a retaining element 22, which is designed such that it allows the fastening device in the form of a tap or arrowhead to be mounted in a fixed position.

1. A cable fastening device comprising:
an arrangement of a first clip and a second clip, wherein the first clip and the second clip are configured to engage around a cable;
a fixing element comprising:
a guide element; and
a retaining element; and
a mount which at least partially surrounds the arrangement of the first clip and the second clip with respect to a casing surface thereof,
wherein the guide element is mechanically connected to the arrangement of the first clip and the second clip,
wherein the retaining element is configured to mount the fastening device in a fixed position, and
wherein the guide element is mounted in the arrangement of the first clip and the second clip in the mount.

2. The cable fastening device as claimed in claim 1, wherein the mount comprises a first groove and a second groove configured to mount the guide element, such that the first groove and the second groove receive an edge or side of the guide element, and
wherein the first groove and the second groove are designed substantially along the curvature of the casing surface.

3. The cable fastening device as claimed in claim 2, wherein the guide element comprises a panel substantially in a form of a casing surface segment of a cylinder and/or designed to correspond to the curvature profile of the casing surface of the arrangement of the first clip and the second clip or is designed depending on the curvature profile.

4. The cable fastening device as claimed in claim 3, wherein the arrangement of the first clip and the second clip is configured to engage around two cables in a force-fitting manner and fix the two cables against rotation and displacement in the arrangement of the first clip and the second clip, and
wherein the first clip and the second clip comprise a retaining means configured to clamp the two cables at an outer circumference thereof.

5. The cable fastening device as claimed in claim 4, wherein the retaining means comprises retaining ribs, retaining protrusions, or retaining fins.

6. The cable fastening device as claimed in claim 5, wherein the retaining ribs are hollow and/or elastic.

7. The cable fastening device as claimed in claim 6, wherein the retaining ribs have a wall thickness lower than one third to one fifth of the average width of the retaining ribs or of the height of the retaining ribs.

8. The cable fastening device as claimed in claim 7, wherein the retaining ribs are substantially trapezoidal with respect to their cross-sectional area, and an inwardly facing side surface of the retaining ribs is rounded in the form of a recess in a top surface of the retaining ribs.

9. The cable fastening device as claimed in claim 8, wherein the arrangement of the first clip and the second clip is of integral design,
wherein the arrangement of the first clip and the second clip comprises two segments connected to one another on one side by means of a film hinge and/or an elastic web, and
wherein an opposing side comprises an interlocking closure means.

10. The cable fastening device as claimed in claim 9, wherein the retaining element is in the form of a tap or arrowhead.

11. The cable fastening device as claimed in claim 10, wherein the first clip and the second clip are arranged side by side to form a combined double clip to each engage around a cable side by side.

12. The cable fastening device as claimed in claim 11, wherein the arrangement of the first clip and the second clip is of an integral design,
wherein the two segments comprise half a clip side by side, and
wherein the two segments are designed as combined to form two full clips configured to surround a cable.

13. The cable fastening device as claimed in claim 12, wherein each half of a clip formed side by side in each segment are each formed as a half-shell, open to a side, at which the half of a clip is jointed with a half-shall of the other segment.

14. The cable fastening device as claimed in claim 13, wherein the arrangement comprises three or more clips arranged side by side.
